(19) United States
(12) Patent Application Publication
(10) Pub. No.: US 2025/0382459 A1
(43) Pub. Date: Dec. 18, 2025

(54) RESIN COMPOSITION AND ARTICLE MANUFACTURED USING THE SAME

(71) Applicant: Elite Material Co., Ltd., Taoyuan City (TW)

(72) Inventors: Yu-Te Lin, Taoyuan City (TW); Hung-Che Wang, Taoyuan City (TW)

(21) Appl. No.: 19/001,772

(22) Filed: Dec. 26, 2024

(30) Foreign Application Priority Data
Jun. 14, 2024 (TW) 113122052

(51) Int. Cl. C08L 79/08; C08K 5/01

(52) U.S. Cl. CPC C08L 79/085; C08K 5/01

(57) ABSTRACT

A resin composition is disclosed. The resin composition includes 100 parts by weight of maleimide resin represented by the formula (1); 1.5 parts by weight to 20 parts by weight of hydrogenated polybutadiene; and 10 parts by weight to 35 parts by weight of a vinylbenzyl-containing compound,

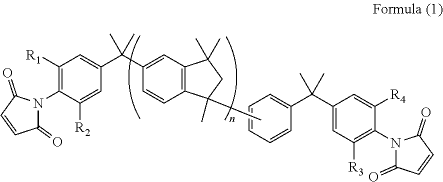

wherein n is an average number of a repeating unit based on a number-average molecular weight, n is a numerical value ranging from 1 to 20, and each R₁to R₄ independently is H or C₁₋₃ alkyl. The invention also provides an article manufactured using the aforesaid resin composition.

### CROSS-REFERENCE TO RELATED APPLICATIONS

This application claims the benefits of the Taiwan Patent Application Serial Number 113122052, filed on Jun. 14, 2024, the subject matter of which is incorporated herein by reference.

### BACKGROUND OF THE INVENTION

### Field

The present invention provides a resin composition and an article manufactured using the same. More specifically, the present invention provides a resin composition with improved properties and an article manufactured using the same.

### Description of Related Art

The operation of electronic equipment is achieved by connecting numerous electronic components through conductive lines on the circuit board for power supply and signal transmission. A circuit board (such as a printed circuit board) is generally composed of an insulating substrate and a conductive circuit pattern located on the insulating substrate, and the laminate is one of the key raw materials for making the circuit board.

With the rapid development of the mobile communication technology and the thinness, smallness and high integration of the current electronic equipment, the corresponding circuit boards used are also developing in the direction of multi-layering, high-density wiring and high-speed signal transmission. In addition, in order to ensure the quality of electronic equipment, there are also higher requirements for the overall performance of laminates. The resin composition is the basic raw material for preparing laminates. The design of the resin composition directly affects the performance of laminates and circuit substrates.

Therefore, how to develop a resin composition suitable for high-performance circuit boards is the current direction of the industry's active efforts.

### SUMMARY OF THE INVENTION

In view of the problems encountered in the prior art, especially the inability of existing resin compositions to meet one or more of the above performance requirements, the main object of the present invention is to provide a resin composition and an article thereof that can meet the above performance requirements.

The present invention provides a resin composition, comprising: 100 parts by weight of maleimide resin represented by the following formula (1); 1.5 parts by weight to 20 parts by weight of hydrogenated polybutadiene; and 10 parts by weight to 35 parts by weight of a vinylbenzyl-containing compound,

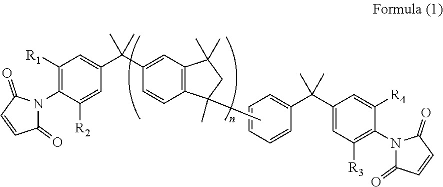

wherein n is an average number of a repeating unit based on a number-average molecular weight, n is a numerical value ranging from 1 to 20, and each R₁ to R₄ independently is H or C₁₋₃ alkyl.

In the present invention, the vinylbenzyl-containing compound may comprise: divinyl diphenylethane, a vinylbenzyl-containing compound represented by the following formula (2) or a combination thereof:

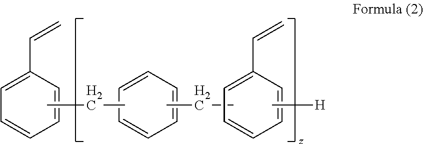

wherein z is an average number of a repeating unit based on a number-average molecular weight, and z is a numerical value ranging from 1 to 20.

The present invention also provides an article manufactured using the aforesaid resin composition, wherein the article includes a prepreg, a resin film, a laminate or a printed circuit board.

The article manufactured using the resin composition of the present invention, such as a prepreg, a resin film, a laminate or a printed circuit board, has excellent characteristics in at least one of: an X-axis coefficient of thermal expansion of the article manufactured using the resin composition of the present invention, whether crystals present on the surface of a prepreg, whether striation bubbles present inside a copper-free laminate and a tensile force on a copper foil, and therefore can be used as a high-performance laminate that meet comprehensive needs.

### BRIEF DESCRIPTION OF DRAWINGS

FIG. 1 is a schematic diagram showing striation bubbles present inside a copper-free laminate.

FIG. 2 is a schematic diagram showing striation bubbles present inside a copper-free laminate indicated by an arrow.

FIG. 3 is a schematic diagram showing no striation bubbles present inside a copper-free laminate.

FIG. 4 is a schematic diagram showing an appearance of a prepreg with crystals.

FIG. 5 is a schematic diagram showing an appearance of a prepreg without crystals.

### DETAILED DESCRIPTION OF THE INVENTION

The following embodiments of the present invention are merely examples and are not intended to limit the present invention.

In the present specification, the terms “comprise”, “include”, “have”, “contain” or any other similar terms are open-ended transitional phrases. The terns “consisting of” and “consist” are closed-transitional phrases.

In the present specification, the term “a composition comprises A, B and C, wherein A comprises a1, a2 or a3” has the same meaning as the term “a composition comprises A, B and C, wherein A comprises a1, a2, a3 or a combination thereof”, that is “a composition comprises A, B and C, where A comprises a1, a2, a3, the combination of a1 and a2, the combination of a1 and a3, the combination of a2 and a3 or the combination of a1, a2 and a3.”

In the present specification, the range “10.0 to 20.0”, “10.0˜20.0”, “between 10.0 and 20.0” or “from 10.0 to 20.0” should be deemed to have been specifically disclosed all subranges such as 10.0 to 20.0, 10.0 to 11.0, 15.0 to 20.0, 11.0 to 19.0 etc.

In the present specification, the numerical values in the present invention include all numerical ranges that are the same as the numerical values after rounding to the number of significant digits of the numerical values.

In the present specification, “polymer” refers to a compound formed by monomers through polymerization reactions, and also includes polymer aggregates, and each polymer can be formed by multiple structural units connected by covalent bonds. In the present specification, “polymer” includes homopolymers, copolymers, prepolymers and the like. “Prepolymer” refers to a product formed by polymerization of multiple compounds, wherein the conversion rate may be greater than 10% (for example, 10% to 90%). “Polymer” may also include oligomers, which may be composed of multiple (for example, 2 to 20, usually 2 to 5) repeating units. For example, when referring to “diene polymer”, it may include diene homopolymers, diene copolymers, diene prepolymers, or diene oligomers.

In the present specification, the “copolymer” refers to the product formed by polymerization reaction of two or more kinds of monomers, and includes but not limited to random copolymers, alternating copolymers, graft copolymers or block copolymers. For example, a styrene-butadiene copolymer is a product obtained by polymerization of only two kinds of monomers of styrene and butadiene. For example, styrene-butadiene copolymers include, but are not limited to styrene-butadiene random copolymers, styrene-butadiene alternating copolymers, styrene-butadiene graft copolymers or styrene-butadiene block copolymers. Styrene-butadiene block copolymers include, but are not limited to, the polymerized molecular structure of styrene-styrene-styrene-butadiene-butadiene-butadiene-butadiene. Styrene-butadiene block copolymers include, for example, but are not limited to, styrene-butadiene-styrene block copolymers. Styrene-butadiene-styrene block copolymers include, for example, but are not limited to, the polymerized molecular structure of styrene-styrene-styrene-butadiene-butadiene-butadiene-butadiene-styrene-styrene-styrene. Similarly, hydrogenated styrene-butadiene copolymers include hydrogenated styrene-butadiene random copolymers, hydrogenated styrene-butadiene alternating copolymers, hydrogenated styrene-butadiene graft copolymers or hydrogenated styrene-butadiene block copolymer. Hydrogenated styrene-butadiene block copolymers include, for example but are not limited to, hydrogenated styrene-butadiene-styrene block copolymers.

In the present invention, the term “resin” may include monomers, polymers formed by monomers, combinations of monomers, combinations of polymers formed by monomers or combinations of monomers and polymers formed by monomers when interpretation. For example, in the present invention, “maleimide resin” includes maleimide monomers, maleimide polymers, combinations of maleimide monomers, combinations of maleimide polymers or combinations of maleimide monomers and maleimide polymers when interpretation.

In the present specification, “vinyl group-containing” may include vinyl group, vinylene group, allyl group, (meth) acrylate group or vinylbenzyl group when interpretation.

Unless otherwise specified, in the present invention, a modification includes: products obtained by modifying reactive functional groups of resins, homopolymers obtained by polymerization of resins, prepolymers obtained by polymerization of resins with other resins, copolymers obtained by polymerization of resins with other resins, or cross-linked polymers obtained by cross-linking resins with other resins, but the present invention is not limited thereto. For example, the modification may be to replace the original terminal hydroxyl group with a terminal vinyl group through a chemical reaction, or to obtain a terminal hydroxyl group through a chemical reaction between the original terminal vinyl group and p-aminophenol.

In the present specification, when specific examples of compounds are written in the form of “(substituent)”, they should be understood to include both cases with this substituent and cases without this substituent when interpretation. For example, cyclohexanedimethanol di(meth)acrylate should be interpreted as including cyclohexanedimethanol diacrylate and cyclohexanedimethanol dimethacrylate; and (meth)acrylate should be interpreted as including acrylate and methacrylate.

The alkyl group described in the present invention includes its various isomers when interpretation, for example, propyl group should be interpreted as including n-propyl group and isopropyl group.

In the present specification, part(s) by weight represents weight part(s), which can be any weight unit, such as but not limited to kilogram(s), gram(s), pound(s) and other weight units. For example, 100 parts by weight of maleimide resin means that it can be 100 kg of maleimide resin or 100 lbs of maleimide resin. If the resin solution includes solvent and resin, the parts by weight of the (solid or liquid) resin generally refers to the weight unit of the (solid or liquid) resin, and does not include the weight unit of the solvent in the solution. The parts by weight of the solvent refer to the weight unit of the solvent.

One embodiment of the present invention provides a resin composition, comprising: 100 parts by weight of maleimide resin represented by the following formula (1); 1.5 parts by weight to 20 parts by weight of hydrogenated polybutadiene; and 10 parts by weight to 35 parts by weight of a vinylbenzyl-containing compound, wherein the vinylbenzyl-containing compound comprises: divinyl diphenylethane, a vinylbenzyl-containing compound represented by the following formula (2) or a combination thereof,

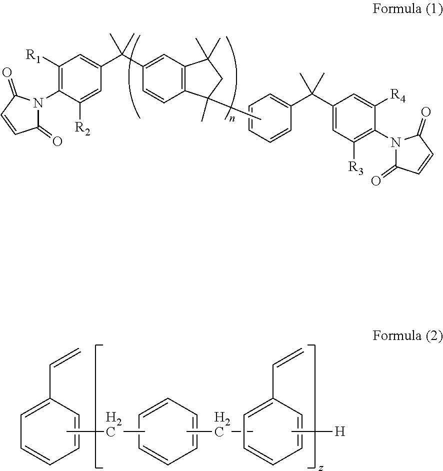

wherein n is an average number of a repeating unit based on a number-average molecular weight, n is a numerical value ranging from 1 to 20, and each R₁ to R₄ independently is H or C₁₋₃ alkyl; wherein z is an average number of a repeating unit based on a number-average molecular weight, and z is a numerical value ranging from 1 to 20.

In the formula (1), n represents the average number of the repeating unit of the structural unit in the bracket based on the number-average molecular weight. That is, the polymerization degree n of the repeating unit of the maleimide resin having the structure represented by the formula (1) is the average number of the repeating unit calculated from the measured value of the number average molecular weight of the maleimide resin having the structure represented by formula (1). Therefore, n is a numerical value between 1 and 20, n may be a positive integer between 1 and 20, or n may also be a non-integer between 1 and 20. For example, in one embodiment, for example but not limited to, n may be 1, 1.2, 2, 3, 4.5, 5, 7, 8.75, 10, 15.3, 19, 20 or 20.3. For example, in one embodiment, the number average molecular weight of the maleimide resin with the structure represented by the formula (1) is 1272, then n value is [(1272−718.94)/158.24]+1=4.495, that is, n is 4.5.

For example, in one embodiment, the maleimide resin represented by the formula (1) of the present invention is a maleimide resin respresented by the following formula (1.1):

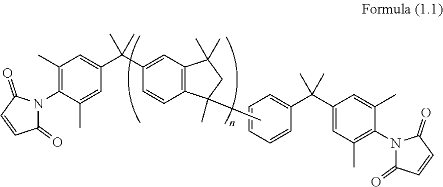

wherein n is an average number of a repeating unit based on a number-average molecular weight, and n is a numerical value ranging from 1 to 20.

In the formula (1.1), n represents the average number of the repeating unit of the structural unit in the bracket based on the number-average molecular weight, and n is a numerical value ranging from 1 to 20. For example, in one embodiment, for example but not limited to, n may be 1, 2, 3, 3.5, 4, 4.5, 5, 7, 7.5, 8, 8.5, 10, 15, 19 or 20.

For example, in one embodiment, the maleimide resin represented by the formula (1) of the present invention is a maleimide resin represented by the following formula (1.1.1):

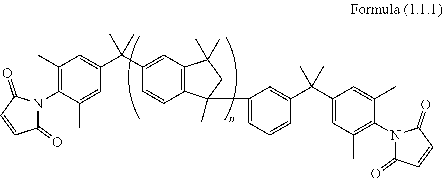

(1.1.1)
wherein n is an average number of a repeating unit based on a number-average molecular weight, and n is a numerical value ranging from 1 to 20.

In the formula (1.1.1), n represents the average number of the repeating unit of the structural unit in the bracket based on the number-average molecular weight, and n is a numerical value ranging from 1 to 20. For example, in one embodiment, for example but not limited to, n may be 1, 2, 3, 3.5, 4, 4.5, 5, 7, 7.5, 8, 8.5, 10, 15, 19 or 20.

For example, in the resin composition of the present invention, hydrogenated polybutadiene is obtained by hydrogenating polybutadiene. Hydrogenated polybutadiene no longer has reactive vinyl groups, or the residual vinyl content in the hydrogenated polybutadiene is less than 7%. In one embodiment, the hydrogenated polybutadiene may not have reactive vinyl bonds. In one embodiment, the hydrogenated polybutadiene mentioned in each embodiment of the present invention may be, for example, but not limited to, BI-1000, BI-2000 and BI-3000 purchased from Nippon Soda Co., Ltd, wherein BI-1000 is a hydrogenated polybutadiene with a number average molecular weight of 1100 to 1300, BI-2000 is a hydrogenated polybutadiene with a number average molecular weight of 2200, and BI-3000 is a hydrogenated polybutadiene with a number average molecular weight of 3300.

For example, in the resin composition of the present invention, with respect to 100 parts by weight of the maleimide resin represented by the formula (1), the content of the hydrogenated polybutadiene may be between 1.5 parts by weight and 20 parts by weight, for example, but not limited to, 1.5 parts by weight, 2 parts by weight, 3 parts by weight, 5 parts by weight, 7 parts by weight, 10 parts by weight, 13 parts by weight, 15 parts by weight or 20 parts by weight of the hydrogenated polybutadiene.

For example, in one embodiment, the divinyl diphenylethane comprises any one or more of isomers of p,p-divinyl-1,2-diphenylethane (p,p-BVPE, the divinyl diphenylethane represented by the formula (3)), p,m-divinyl-1,2-diphenylethane (p,m-BVPE, the divinyl diphenylethane represented by the formula (4)) and m,m-divinyl-1,2-diphenylethane (m,m-BVPE, the divinyl diphenylethane represented by the formula (5)). Herein, p stands for the para-position, m stands for the meta-position.

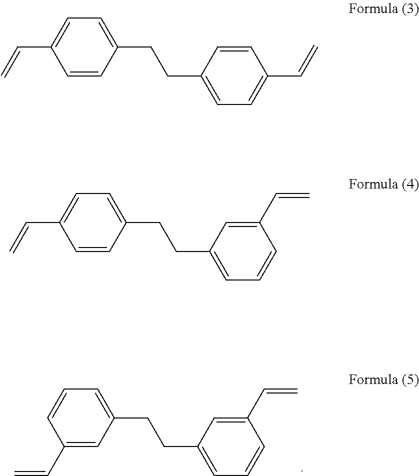

In the formula (2), z represents the average number of the repeating unit of the structural unit in the bracket based on the number average molecular weight, z is the average number of the repeating unit based on number average molecular weight, and z is a numerical value ranging from 1 to 20. For example, in one embodiment, for example but not limited to, z may be 1, 2, 3, 4, 5, 6, 7, 8, 9, 10, 11, 12, 13, 14, 15, 16, 17, 18, 19 or 20. The vinylbenzyl-containing compound having the structure represented by the formula (2) may be obtained from commercial products, or may be prepared according to known methods, for example, by referring to the content disclosed in Taiwan Patent Publication No. TWI822584 to obtain the vinylbenzyl-containing compound represented by the formula (2).

For example, in one embodiment, the vinylbenzyl-containing compound represented by the formula (2) of the present invention may be the vinylbenzyl-containing compound represented by the formula (2.1):

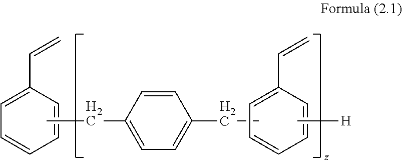

wherein z is the average number of the repeating unit based on the number average molecular weight, and z is a numerical value ranging from 1 to 20.

For example, in the resin composition of the present invention, with respect to 100 parts by weight of the maleimide resin represented by the formula (1), the content of the vinylbenzyl-containing compound may be between 10 parts by weight and 35 parts by weight, for example, but not limited to 10 parts by weight, 20 parts by weight, 30 parts by weight or 35 parts by weight of the vinylbenzyl-containing compound.

In one embodiment, the resin composition may optionally further comprise other types of maleimide resins other than the maleimide resin represented by the formula (1) of the present invention, and the content of the maleimide resin is not limited.

In one embodiment, the maleimide resin may comprise 4,4′-diphenylmethane bismaleimide, polyphenylmethane maleimide (or called as oligomer of phenylmethane maleimide), bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl) hexane, N-2,3-xylylmaleimide, N-2,6-xylylmaleimide, N-phenylmaleimide, vinyl benzyl maleimide, maleimide with biphenyl structure, maleimide resin containing C₁₀₋₅₀ aliphatic structure, prepolymer of diallyl compound and maleimide resin, prepolymer of multifunctional amine and maleimide resin (herein, the multifunctional amine includes two or more amine groups), prepolymer of aminophenol and maleimide resin, or a combination thereof.

For example, specific examples of other types of maleimide resin include, but are not limited to, maleimide resin produced by Daiwakasei Industry Co., Ltd. with trade names BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000 or BMI-7000H, maleimide resin produced by K.I Chemical Co., Ltd. with trade names BMI-70 or BMI-80, or maleimide resin produced by Nippon Kayaku Co., Ltd. with trade names MIR-3000 or MIR-5000.

For example, specific examples of maleimide resin containing C₁₀₋₅₀ aliphatic structure include, but are not limited to, maleimide resin containing C₁₀₋₅₀ aliphatic structure produced by Designer Molecular Co., Ltd. with trade names BMI-689, BMI-1400, BMI-1500, BMI-1700, BMI-2500, BMI-3000, BMI-5000 or BMI-6000, or maleimide resin containing C₁₀₋₅₀ aliphatic structure produced by Shin-etsu chemical co., Ltd. with trade names SLK-3000 series, SLK-1500 series or SLK-2000 series. The structure of SLK-3000 produced by Shin-etsu chemical co., Ltd. is the same as the structure of BMI-3000 produced by Designer Molecular Co., Ltd.

For example, in one embodiment, with respect to 100 parts by weight of the maleimide resin represented by the formula (1) of the present invention, the resin composition may further comprise 5 parts by weight to 15 parts by weight of the aforesaid maleimide resin containing C₁₀₋₅₀ aliphatic structure.

In one embodiment, the resin composition may further comprise vinyl-containing polyphenylene ether resin, triallyl isocyanurate or a combination thereof.

For example, in one embodiment, the vinyl-containing polyphenylene ether resin may include various polyphenylene ether resins with terminals modified by vinyl or allyl. In addition, the vinyl-containing polyphenylene ether resin may be polyphenylene ether resin with terminals modified by (meth)acrylate.

For example, in one embodiment, the vinyl-containing polyphenylene ether resin represents a polyphenylene ether resin containing vinyl groups, and specific examples thereof include but are not limited to polyphenylene ether resins containing a vinyl group, an allyl group, a vinyl benzyl group or a (meth)acrylate group. For example, in one embodiment, the vinyl-containing polyphenylene ether resin comprises: vinylbenzyl biphenyl polyphenylene ether resin, (meth) acrylate polyphenylene ether resin ((meth)acrylyl polyphenylene ether resin), allyl polyphenylene ether resin, vinyl benzyl modified bisphenol A polyphenylene ether resin, vinyl chain extended polyphenylene ether resin or a combination thereof. For example, the vinyl-containing polyphenylene ether resin may be vinylbenzyl biphenyl polyphenylene ether resin with a number average molecular weight of approximately 1200 (such as OPE-2st 1200, available from Mitsubishi Gas Chemical Co., Ltd.), vinylbenzyl biphenyl polyphenylene ether resin with a number average molecular weight of approximately 2200 (such as OPE-2st 2200, available from Mitsubishi Gas Chemical Co., Ltd.) or methacrylate polyphenylene ether resin with a number average molecular weight of approximately 1900 to 2300 (such as SA9000, available from Sabic). The vinyl chain extended polyphenylene ether resin may comprise various types of polyphenylene ether resins disclosed in U.S. Patent Application Publication No. 2016/0185904 A1, which is incorporated herein by reference in its entirety.

For example, in one embodiment, with respect to 100 parts by weight of the maleimide resin represented by the formula (1), the resin composition may further comprises: 5 parts by weight to 40 parts by weight of vinyl-containing polyphenylene ether resin, triallyl isocyanurate or a combination thereof, for example, but not limited to, 5 parts by weight to 40 parts by weight of triallyl isocyanurate, 5 parts by weight to 40 parts by weight of vinyl-containing polyphenylene ether resin, or 20 parts by weight of triallyl isocyanurate and 20 parts by weight of vinyl-containing polyphenylene ether resin.

In one embodiment, the resin composition may further comprise an inorganic filler, a hardening accelerator, an inhibitor, a flame retardant, a colorant, a toughener, a core-shell rubber, a silane coupling agent or a solvent. The aforesaid components may be used alone or in combination.

In one embodiment, the resin composition may further comprise an inorganic filler, and the content of the inorganic filler is not limited. In another embodiment, with respect to 100 parts by weight of the maleimide resin represented by the formula (1), the resin composition may further comprise 20 parts by weight to 230 parts by weight of the inorganic filler, 20 parts by weight to 210 parts by weight of the inorganic filler, 20 parts by weight to 80 parts by weight of the inorganic filler, 25 parts by weight to 135 parts by weight of the inorganic filler, 30 parts by weight to 100 parts by weight of the inorganic filler, or 30 parts by weight to 150 parts by weight of the inorganic filler. However, the present invention is not limited thereto, and the content of the inorganic filler may be adjusted according to the needs.

In one embodiment, the inorganic filler may be silica. In one embodiment, the inorganic filler may be spherical silica. The spherical silica may include various types of spherical silica known in the art, and the particle size distribution D50 of the spherical silica may be, for example, less than or equal to 2.0 μm. For example, the particle size distribution D50 of the spherical silica may preferably range from 0.2 μm to 2.0 μm, for example, but not limited to 0.2 μm, 0.3 μm, 0.4 μm, 0.6 μm, 0.8 μm, 1.2 μm, 1.3 μm or 2.0 μm. The particle size distribution D50 refers to the particle size corresponding to the cumulative volume distribution of fillers (such as but not limited to spherical silica) reaching 50% as measured by laser scattering. The spherical silica suitable for the present invention is not particularly limited, and may be any one or more commercially available products, such as but not limited to spherical silica purchased from Admatechs Company.

In one embodiment, the spherical silica may optionally be pretreated with siloxane if it is needed. Siloxane may comprise amino silane, epoxy silane, vinyl silane, ester silane, hydroxysilane, isocyanurate silane, methacryloxysilane or acryloxysilane. With respect to 100 parts by weight of the spherical silica, the amount of the aforesaid siloxane for pretreatment may range from 0.005 parts by weight to 0.5 parts by weight, but the present invention is not limited thereto. The amount of the siloxane is not particularly limited, and the adding amount of the siloxane may be adjusted according to the dispersion of the inorganic filler in the resin composition.

In one embodiment, the inorganic filler in the resin composition may be an inorganic filler other than the spherical silica, and the content thereof may be adjusted according to the needs.

In one embodiment, the inorganic filler other than the spherical silica may comprise, but are not limited to, non-spherical silica (that is, the known irregular type silica, and the irregular type silica is not spherical silica), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate modified talc, zinc oxide, zirconia, mica, boehmite (AlOOH), calcined talc, talc, silicon nitride or calcined kaolin. In addition, except for the aforementioned non-spherical silica, the rest of the aforementioned inorganic fillers can be spherical, fibrous, plate-like, granular, flake-like, needle-like or whisker-like. The inorganic fillers other than the spherical silica may selectively be pretreated with siloxane if it is needed. The examples and amount of the siloxane used to pretreat the inorganic fillers are as mentioned above, and are not repeated here.

For example, the hardening accelerator (including hardening initiator) may include a catalyst such as a Lewis base or a Lewis acid. The Lewis acid may comprise one or more of imidazole, boron trifluoride amine complex, ethyltriphenyl phosphonium chloride, 2-methylimidazole (2MI), 2-phenyl-1H-imidazole (2PZ), 2-ethyl-4-methylimidazole (2E4MI), 2-undecyl-1H-imidazole (C11Z), triphenylphosphine (TPP) and 4-dimethylaminopyridine (DMAP). The Lewis acid may comprise a metal salt compound such as a metal salt compound of manganese, iron, cobalt, nickel, copper or zinc, or a metal catalyst such as zinc octoate or cobalt octoate. The hardening accelerator may also include a hardening initiator such as a peroxide that can generate free radicals. The hardening initiator may comprise, but is not limited to: dicumyl peroxide, tert-butyl peroxybenzoate, dibenzoyl peroxide (BPO), 2,5-dimethyl-2,5-di(tert-butylperoxy)-3-hexyne (25B), bis(tert-butylperoxyisopropyl)benzene or a combination thereof. For example, with respect to 100 parts by weight of the maleimide resin represented by the formula (1), the content of the hardening accelerator used in the present invention is not particularly limited, and may be, for example, 0.01 parts by weight to 1.0 parts by weight, 0.05 parts by weight to 0.5 parts by weight, 0.05 parts by weight to 0.1 parts by weight, 0.02 parts by weight to 0.08 parts by weight, 0.15 parts by weight to 0.5 parts by weight or 0.1 parts by weight to 0.2 parts by weight.

In one embodiment, the resin composition may further comprise an inhibitor, and the content of the inhibitor is not particularly limited.

The inhibitor in the resin composition may be any one or more inhibitors suitable for making prepregs, resin films, laminates or printed circuit boards. The inhibitor may include various molecular polymerization inhibitors or stable free radical polymerization inhibitors known in the art. The molecular polymerization inhibitors may include, but are not limited to, phenolic compounds, quinone compounds, aromatic amine compounds, aromatic hydrocarbon nitro compounds, sulfur-containing compounds or variable-valent metal chlorides. More specifically, the molecular polymerization inhibitors may include, but are not limited to, phenol, hydroquinone, 4-tert-butylcatechol, benzoquinone, chloranil, 1,4-naphthoquinone, trimethylquinone, aniline, nitrobenzene, Na₂S, FeCl₃, or CuCl₂. The stable free radical polymerization inhibitors may include, but are not limited to, 1,1-diphenyl-2-trinitrophenylhydrazine (DPPH), triphenylmethyl free radical, 2,2,6,6-tetramethyl piperidine-1-oxide or derivatives of 2,2,6,6-tetramethylpiperidine-1-oxide.

In one embodiment, the resin composition may further comprise a flame retardant. In another embodiment, the resin composition may not comprise the flame retardant, and at this time the content of the flame retardant is 0 parts by weight; here, it means that the flame retardant is not intentionally added into the resin composition.

The flame retardant comprises phosphorus-containing flame retardants. For example, the phosphorus-containing flame retardants may comprise: ammonium polyphosphate, hydroquinone bis(diphenyl phosphate), bisphenol A bis(diphenylphosphate), tri(2-carboxyethyl) phosphine (TCEP), tris(chloroisopropyl)phosphate, trimethyl phosphate (TMP), dimethyl methyl phosphonate (DMMP), resorcinol bis(dixylenyl phosphate), RDXP (such as commercially available products PX-200, PX-201 or PX-202), phosphazene (such as commercially available products SPB-100, SPH-100 or SPV-100), melamine polyphosphate, 9,10-dihydro-9-oxa-10-phosphaphenanthrene-10-oxide (DOPO) or derivatives thereof (such as di-DOPO compound) or resin thereof (such as DOPO-HQ, DOPO-NQ, DOPO-PN or DOPO-BPN), DOPO-bonding epoxy resin, diphenylphosphine oxide (DPPO) or derivatives thereof (such as di-DPPO compound) or resin thereof, melamine cyanurate, tri-hydroxyethyl isocyanurate or aluminum phosphinate (such as commercially available products OP-930 or OP-935). Herein, DOPO-PN is DOPO phenol novolak resin, DOPO-BPN may be bisphenol novolac resin such as DOPO-BPAN (DOPO-bisphenol A novolac), DOPO-BPFN (DOPO-bisphenol F novolac) or DOPO-BPSN (DOPO-bisphenol S novolac).

In one embodiment, the content of the colorant, the toughener or the core-shell rubber is not particularly limited, and may be adjusted according to the needs.

The colorant suitable for use in the present invention may include, but is not limited to, dyes or pigments.

The main function of the toughener is to improve the toughness of the resin composition. The toughener suitable for the present invention may include, but are not limited to, carboxyl-terminated butadiene acrylonitrile rubber (CTBN) and other rubbers.

In the present invention, the core-shell rubber suitable for the present invention may include various commercially available core-shell rubbers.

For example, the silane coupling agent may comprise silane (for example, but not limited to siloxane), and may be divided into amino silane, epoxide silane, vinyl silane, acrylate silane, methacrylate silane, hydroxysilane, isocyanate silane, methacryloxysilane and acryloxysilane according to the types of the functional groups.

The main function of adding solvent is to dissolve the components in the resin composition, change the solid content of the resin composition, and adjust the viscosity of the resin composition. Examples of the solvent may include, but are not limited to, methanol, ethanol, ethylene glycol monomethyl ether, acetone, butanone (also known as methyl ethyl ketone), methyl isobutyl ketone, cyclohexanone, toluene, xylene, methoxyethyl acetate, ethoxyethyl acetate, propoxyethyl acetate, ethyl acetate, propylene glycol methyl ether, dimethylformamide, dimethylacetamide, nitromethylpyrrolidone or a combination thereof. The adding amount of the aforesaid solvent is not particularly limited, and may be adjusted according to the desired viscosity of the resin composition. If a solvent is added to the resin composition, the solvent will evaporate and be removed when the resin composition is heated to a high temperature to form a semi-cured state. Therefore, there is no solvent in the prepreg or the resin film, or there is only a trace amount of solvent in the prepreg or the resin film. For example, in one embodiment, with respect to 100 parts by weight of the maleimide resin represented by the formula (1), the adding amount of the solvent may be, for example, 10 parts by weight to 90 parts by weight, 30 parts by weight to 50 parts by weight or 60 parts by weight to 80 parts by weight.

The resin composition according to one embodiment of the present invention can be made into various products through various processing methods, including but not limited to prepregs, resin films, laminates or printed circuit boards.

For example, the resin composition provided by one embodiment the present invention can be used to prepare a prepreg, which may include a reinforcing material and a layered structure disposed thereon. The layered structure may be formed by heating the aforementioned resin composition to a high temperature to form a semi-cured state (B-stage). The baking temperature for preparing the prepreg may be between 120° C. and 180° C., and preferably between 130° C. and 150° C. The baking time may be 2 minutes to 6 minutes. The reinforcing material may be any one of fiber material, woven fabric, and non-woven fabric, and the woven fabric preferably includes glass fiber fabric. The type of the glass fiber fabric is not particularly limited, and can be various commercially available glass fiber fabrics that can be used for printed circuit boards, such as E-type glass fiber fabric, D-type glass fiber fabric, S-type glass fiber fabric, T-type glass fiber fabric, L-type glass fiber fabric or Q-type quartz fiber fabric, wherein the types of fibers may include yarn or roving, and the form may include spread form or standard form. The non-woven fabric preferably includes liquid crystal resin non-woven fabric or quartz non-woven fabric. The liquid crystal resin non-woven fabric may be, for example, polyester non-woven fabric, polyurethane non-woven fabric, etc., and is not limited thereto. The woven fabric may also include liquid crystal resin woven fabric, such as polyester woven fabric or polyurethane woven fabric, and is not limited thereto. The reinforcing material can increase the mechanical strength of the prepreg. In one preferred embodiment, the reinforcing material may also be selectively pretreated with a siloxane compound. After the prepreg is subsequently heated for curing (C-stage), an insulating layer can be formed.

For example, the resin composition of one embodiment of the present invention may be made into a resin film, which is obtained by heating and baking to semi-cure the resin composition. The resin composition may be selectively applied on a polyethylene terephthalate film (PET film), a polyimide film (PI film), a copper foil or a resin-coated copper foil, followed by heating and baking to semi-cure the resin composition to form a resin film.

For example, the resin composition of one embodiment of the present invention can be made into a laminate. For example, the laminate may include at least two metal foils and at least one insulating layer, the insulating layer is disposed between the two metal foils, and the insulating layer may be formed by laminating and curing the aforementioned resin composition at high temperature and under high pressure (C-stage). The suitable curing temperature may be, for example, between 200° C. and 240° C., and preferably between 210° C. and 230° C.; the curing time may be 120 minutes to 200 minutes, and preferably 140 minutes to 180 minutes; and the suitable pressure may be 400 psi to 600 psi, and preferably 450 psi to 550 psi. The insulating layer may be obtained by curing at least one prepreg or at least one resin film. The metal foil can be made of copper, aluminum, nickel, platinum, silver, gold or alloys thereof. For example, the metal foil may be a copper foil. In a preferred embodiment, the laminate is a copper-clad laminate.

For example, in one embodiment, the aforementioned laminate can be further processed into a printed circuit board after circuit processing, and the manufacturing method of the printed circuit board can be any known manufacturing method.

For example, the article manufactured by the resin composition provided by one embodiment of the present invention has at least one of the following characteristics:
a dielectric constant measured at a frequency of 10 GHz with reference to a method described in JIS C2565 being less than or equal to 3.20, for example, the dielectric constant being less than or equal to 3.15;
a dissipation factor measured at a frequency of 10 GHz with reference to a method described in JIS C2565 being less than or equal to 0.00210, for example, the dissipation factor being less than or equal to 0.00203;
no striation bubbles observed inside a copper-free laminate by using an optical microscope;
an X-axis coefficient of thermal expansion measured with reference to a method described in IPC-TM-650 2.4.24.5 being less than or equal to 10.0 ppm/° C., for example, the X-axis coefficient of thermal expansion being less than or equal to 9.9 ppm/° C.;
no crystal observed on a surface of a prepreg by using an optical microscope;
an interlayer bonding strength measured with reference to the method described in IPC-TM-650 2.4.8 being greater than or equal to 2.3 pounds/inch;
a peel strength of a copper foil of a copper-containing laminate measured with reference to a method described in IPC-TM-650 2.4.8 being greater than or equal to 2.7 pounds/inch;
no board explosion occurred when a copper-containing laminate is examined by solder dipping with reference to a method described in IPC-TM-650 2.4.23;
the number of times without board explosion being more than 20 times when conducting a heat resistance of a multilayer laminate with reference to a method described in IPC-TM-650 2.4.13.1
a high temperature stiffness difference measured with reference to an IPC-TM-650 2.4.24.4 standard being less than or equal to 40.0%, for example, the high temperature stiffness difference being less than or equal to 39.4%.

The chemical materials used in the following embodiments and comparative embodiments of the present invention are as follows.

Maleimide A: maleimide resin represented by the formula (1.1.1) purchased from DIC Company, wherein n is a value from 1 to 5.

Maleimide B: maleimide resin represented by the formula (1.1.1) purchased from DIC Company, wherein n is a value from 6 to 10.

BMI-2300: phenylmethane maleimide oligomer, commercially available.

BMI-70: 3,3′-dimethyl-5,5′-diethyl-4,4′-diphenylmethane bismaleimide, commercially available.

BMI-80: bisphenol A diphenyl ether bismaleimide, commercially available.

BMI-3000: maleimide containing C10-50 aliphatic structure, purchased from Designer Molecular Co., Ltd.

BI-3000: hydrogenated polybutadiene with Mn of 3300, purchased from Nippon Soda Co., Ltd.

BI-1000: hydrogenated polybutadiene with Mn of 1100 to 1300, purchased from Nippon Soda Co., Ltd.

BVPE: divinyl diphenylethane which is a mixture of p,p-BVPE and p,m-BVPE, commercially available.

Vinylbenzyl-containing compound represented by the formula (2), wherein z is a value from 1 to 20: commercially available.

Divinylbenzene copolymer: divinylbenzene-styrene-ethylstyrene terpolymer, as described in Synthesis Example 1.

Divinylbenzene: p-divinylbenzene, commercially available.

B-3000: polybutadiene with Mn of 3200, purchased from Nippon Soda Co., Ltd.

B-1000: polybutadiene with Mn of 1200, purchased from Nippon Soda Co., Ltd.

Ricon 150: polybutadiene with Mn of 3900, commercially available.

H1052: hydrogenated styrene-butadiene-styrene triblock copolymer, commercially available.

H1054: hydrogenated styrene-butadiene-styrene triblock copolymer, commercially available.

SA9000: methacrylate-containing polyphenylene ether resin, commercially available.

TAIC: triallyl isocyanurate, commercially available.

C11Z: 2-undecyl imidazole, commercially available.

2Pz: 2-phenylimidazole, commercially available.

25B: 2,5-dimethyl-2,5-bis (tertiary butylperoxy)-3-hexyne, commercially available.

TPP: triphenylphosphine, commercially available.

SC2050 SMJ: spherical silica with surface treated with silane coupling agent, commercially available.

SC2050 SVJ: spherical silica with surface treated with silane coupling agent, commercially available.

MEK: butanone, commercially available.

Toluene: toluene, commercially available.

Synthesis Example 1: Preparation of divinylbenzene-styrene-ethylstyrene terpolymer

3.0 moles (390.6 g) of divinylbenzene, 1.8 moles (229.4 g) of ethylvinylbenzene, 10.2 moles (1066.3 g) of styrene and 15.0 moles (1532.0 g) of n-propyl acetate were added in a reactor to obtain a polymerization solution. The polymerization solution was continuously stirred to mix evenly, the temperature of the polymerization solution was raised to 70° C., and 600 millimoles of boron trifluoride diethyl ether complex was added to the polymerization solution, followed by continuously stirring to allow the polymerization reaction to react for 4 hours. Then, sodium bicarbonate aqueous solution was added to terminate the polymerization reaction. The oil layer was then washed three times with pure water, and the volatile components were removed under reduced pressure at 60° C. to obtain divinylbenzene-styrene-ethylstyrene terpolymer.

The resin compositions of Embodiments and Comparative embodiments of the present invention were prepared according to the amounts of the above-mentioned various raw materials listed in Table 1 to Table 4 below, and further prepared into various test samples.

TABLE 1
The components of the resin composition of Embodiments E1 to E4 (unit: parts by weight)

| Material | Compound | Name | E1 | E2 | E3 | E4 |
|---|---|---|---|---|---|---|
| Maleimide resin | Formula (1.1.1) | Maleimide A | 100 | 100 | 100 | |
| | | Maleimide B | | | | 100 |
| | Aromatic maleimide | BMI-2300 | | | | |
| | | BMI-70 | | | | |
| | | BMI-80 | | | | |
| | Aliphatic maleimide | BMI-3000 | | | | |
| Polyolefin | Hydrogenated polybutadiene | BI-3000 | 3 | 10 | 20 | 10 |
| | | BI-1000 | | | | |
| Vinylbenzyl-containing | BVPE | BVPE | 10 | 35 | 20 | |

| | | |
|---|---|---|
| compound | Vinylbenzyl-containing compound | 35 |
| | represented by the Formula (2) | |
| Divinylbezene | Divinyl benzene copolymer | |
| | Divinyl benzene | |

| | | | | | | |
|---|---|---|---|---|---|---|
| Polyolefin | Polybutadiene | B-3000 | | | | |
| | | B-1000 | | | | |
| | | Ricon 150 | | | | |
| Hydrogenated polyolefin | Hydrogenated styrene-butadiene- | H1052 | | | | |
| | styrene triblock copolymer | H1054 | | | | |
| Additional additive | Polyphenylene ether | SA9000 | | | | |
| | Triallyl isocyanurate | TAIC | | | | |
| Hardening accelerator | Imidazole | C11Z | 0.1 | 0.1 | 0.1 | 0.1 |
| | | 2Pz | | | | |
| | Peroxide | 25B | | | | |
| | Triphenylphosphine | TPP | | | | |
| Inorganic filler | Spherical silica | SC2050 SMJ | 100 | 150 | 150 | 150 |
| | | SC2050 SVJ | 30 | 30 | 30 | 30 |

| Solvent | Butanone | 30 | 10 | 10 | 30 |
|---|---|---|---|---|---|
| | Toluene | 50 | 80 | 80 | 30 |

| Characteristics | Test condition | Unit | E1 | E2 | E3 | E4 |
|---|---|---|---|---|---|---|
| Dk | | No unit | 3.15 | 3.05 | 3.05 | 3.03 |
| Df | | No unit | 0.00203 | 0.00185 | 0.00182 | 0.00167 |
| Observation of striation | | No unit | No | No | No | No |
| bubbles | | | | | | |
| X- CTE | | ppm/° C. | 9.9 | 8.1 | 9.6 | 9.8 |
| Appearance of prepreg | | No unit | No | No | No | No |
| Interlayer bonding strength | | lb/in | 2.8 | 2.7 | 2.5 | 2.3 |
| Copper foil peel strength | | lb/in | 3.3 | 3.1 | 2.8 | 2.7 |
| Solder dipping | | No unit | OK | OK | OK | OK |
| Multilayer laminate heat | | No unit | OK | OK | OK | OK |
| resistance | | | | | | |
| High temperature | Stiffness 1 | N/m | 3140.12 | 4140.96 | 4280.54 | 1768.21 |
| stiffness difference | (@50° C.) | | | | | |
| | Stiffness 2 | N/m | 2056.34 | 2752.44 | 2858.94 | 1102.79 |
| | (@250° C.) | | | | | |
| | ΔStiffness | % | 34.5% | 33.5% | 33.2% | 37.6% |
| | (@50° C. − 250° C.) | | | | | |

TABLE 2
The components of the resin composition of Embodiments E5 to E8 (unit: parts by weight)

| Material | Compound | Name | E5 | E6 | E7 | E8 |
|---|---|---|---|---|---|---|
| Maleimide resin | Formula (1.1.1) | Maleimide A | 80 | 60 | 90 | 100 |
| | | Maleimide B | 20 | 40 | 10 | |
| | Aromatic maleimide | BMI-2300 | | | | |
| | | BMI-70 | | | | |
| | | BMI-80 | | | | |
| | Aliphatic maleimide | BMI-3000 | | 5 | 15 | |
| Polyolefin | Hydrogenated polybutadiene | BI-3000 | 7 | 13 | 15 | 1.5 |
| | | BI-1000 | 13 | 7 | 5 | |
| Vinylbenzyl-containing | BVPE | BVPE | 20 | | 25 | 20 |
| compound | Vinylbenzyl-containing compound | | 10 | 20 | 5 | |
| | represented by the Formula (2) | | | | | |
| Divinylbezene | Divinyl benzene copolymer | | | | | |
| | Divinyl benzene | | | | | |
| Polyolefin | Polybutadiene | B-3000 | | | | |
| | | B-1000 | | | | |
| | | Ricon 150 | | | | |
| Hydrogenated polyolefin | Hydrogenated styrene- | H1052 | | | | |
| | butadiene- | | | | | |
| | styrene triblock copolymer | H1054 | | | | |
| Additional additive | Polyphenylene ether | SA9000 | | | 20 | 15 |
| | Triallyl isocyanurate | TAIC | | 5 | 20 | 10 |
| Hardening accelerator | Imidazole | C11Z | 0.05 | 0.5 | 0.08 | 0.15 |
| | | 2Pz | 0.05 | | 0.02 | 0.01 |
| | Peroxide | 25B | | | 0.05 | 0.05 |
| | Triphenylphosphine | TPP | 0.1 | | | |
| Inorganic filler | Spherical silica | SC2050 SMJ | 135 | 80 | 210 | 150 |
| | | SC2050 SVJ | 25 | 20 | 20 | 20 |

| Solvent | Butanone | 30 | 30 | 10 | 10 |
|---|---|---|---|---|---|
| | Toluene | 50 | 30 | 80 | 80 |

| Characteristics | Test condition | Unit | E5 | E6 | E7 | E8 |
|---|---|---|---|---|---|---|
| Dk | | No unit | 3.05 | 3.05 | 3.05 | 3.15 |
| Df | | No unit | 0.00188 | 0.00175 | 0.00179 | 0.00186 |
| Observation of striation | | No unit | No | No | No | No |
| bubbles | | | | | | |
| X- CTE | | ppm/° C. | 9.2 | 9.6 | 9.9 | 9.5 |
| Appearance of prepreg | | No unit | No | No | No | No |
| Interlayer bonding strength | | lb/in | 2.6 | 2.5 | 2.5 | 2.7 |
| Copper foil peel strength | | lb/in | 3.2 | 2.8 | 2.7 | 3.1 |
| Solder dipping | | No unit | OK | OK | OK | OK |
| Multilayer laminate heat | | No unit | OK | OK | OK | OK |
| resistance | | | | | | |
| High temperature | Stiffness 1 | N/m | 4660.61 | 3950.82 | 3640.96 | 3690.16 |
| stiffness difference | (@50° C.) | | | | | |
| | Stiffness 2 | N/m | 2896.56 | 2394.61 | 2262.33 | 2372.63 |
| | (@250° C.) | | | | | |
| | ΔStiffness | % | 37.9% | 39.4% | 37.9% | 35.7% |
| | (@50° C. − 250° C.) | | | | | |

TABLE 3
The components of the resin composition of Comparative embodiments C1 to C5 (unit: parts by weight)

| Material | Compound | Name | C1 | C2 | C3 | C4 | C5 |
|---|---|---|---|---|---|---|---|
| Maleimide resin | Formula (1.1.1) | Maleimide A | 100 | 100 | 100 | 100 | 100 |
| | | Maleimide B | | | | | |
| | Aromatic maleimide | BMI-2300 | | | | | |
| | | BMI-70 | | | | | |
| | | BMI-80 | | | | | |
| | Aliphatic maleimide | BMI-3000 | | | | | |
| Polyolefin | Hydrogenated | BI-3000 | 45 | | | | |
| | polybutadiene | BI-1000 | | | | | |
| Vinylbenzyl- | BVPE | BVPE | | 45 | 35 | 35 | 35 |

| | |
|---|---|
| containing | Vinylbenzyl-containing compound |
| compound | represented by the Formula (2) |
| Divinylbezene | Divinyl benzene copolymer |
| | Divinyl benzene |

| | | | | | | | |
|---|---|---|---|---|---|---|---|
| Polyolefin | Polybutadiene | B-3000 | | | 10 | 20 | |
| | | B-1000 | | | | | 8 |
| | | Ricon 150 | | | | | 2 |
| Hydrogenated | Hydrogenated styrene- | H1052 | | | | | |
| polyolefin | butadiene-styrene | H1054 | | | | | |
| | triblock copolymer | | | | | | |
| Additional additive | Polyphenylene ether | SA9000 | | | | | |
| | Triallyl isocyanurate | TAIC | | | | | |
| Hardening | Imidazole | C11Z | 0.1 | 0.1 | 0.1 | 0.1 | 0.1 |
| accelerator | | 2Pz | | | | | |
| | Peroxide | 25B | | | | | |
| | Triphenylphosphine | TPP | | | | | |
| Inorganic filler | Spherical silica | SC2050 SMJ | 150 | 150 | 150 | 150 | 150 |
| | | SC2050 SVJ | 30 | 30 | 30 | 30 | 30 |

| Solvent | Butanone | 10 | 10 | 10 | 10 | 10 |
|---|---|---|---|---|---|---|
| | Toluene | 80 | 80 | 80 | 80 | 80 |

| Characteristics | Test condition | Unit | C1 | C2 | C3 | C4 | C5 |
|---|---|---|---|---|---|---|---|
| Dk | | No unit | Unmeasurable | 3.03 | 3.16 | 3.25 | 3.14 |
| Df | | No unit | Unmeasurable | 0.00207 | 0.00234 | 0.00245 | 0.00254 |
| Observation of | | No unit | Yes | No | No | No | No |
| striation bubbles | | | | | | | |
| X- CTE | | ppm/° C. | Unmeasurable | 8.9 | 9.2 | 11.3 | 9.9 |
| Appearance of | | No unit | No | Yes | Yes | Yes | Yes |
| prepreg | | | | | | | |
| Interlayer bonding | | lb/in | Unmeasurable | 2.3 | 2.5 | 2.6 | 2.6 |
| strength | | | | | | | |
| Copper foil peel | | lb/in | <1 | 2.5 | 2.7 | 2.8 | 3.0 |
| strength | | | | | | | |
| Solder dipping | | No unit | Fail | OK | OK | OK | OK |
| Multilayer laminate | | No unit | Unmeasurable | OK | OK | OK | OK |
| heat resistance | | | | | | | |
| High temperature | Stiffness 1 | N/m | Unmeasurable | 2735.21 | 1656.31 | 1742.31 | 1598.31 |
| stiffness difference | (@50° C.) | | | | | | |
| | Stiffness 2 | N/m | Unmeasurable | 2002.79 | 1025.37 | 859.37 | 938.37 |
| | (@250° C.) | | | | | | |
| | ΔStiffness | % | Unmeasurable | 26.8% | 38.1% | 50.7% | 41.3% |
| | (@50° C. − 250° C.) | | | | | | |

TABLE 4
The components of the resin composition of Comparative embodiments C6 to C10 (unit: parts by weight)

| Material | Compound | Name | C6 | C7 | C8 | C9 | C10 |
|---|---|---|---|---|---|---|---|
| Maleimide resin | Formula (1.1.1) | Maleimide A | 100 | 100 | 100 | | |
| | | Maleimide B | | | | | |
| | Aromatic maleimide | BMI-2300 | | | | 100 | |
| | | BMI-70 | | | | | 50 |
| | | BMI-80 | | | | | 50 |
| | Aliphatic maleimide | BMI-3000 | | | | | |
| Polyolefin | Hydrogenated | BI-3000 | | | 10 | 10 | 10 |
| | polybutadiene | BI-1000 | | | | | |
| Vinylbenzyl- | BVPE | BVPE | 35 | | | 35 | 35 |

| | | | |
|---|---|---|---|
| containing | Vinylbenzyl-containing compound | | |
| compound | represented by the Formula (2) | | |
| Divinylbezene | Divinyl benzene copolymer | 15 | 35 |
| | Divinyl benzene | 20 | |

| | | | | | | | |
|---|---|---|---|---|---|---|---|
| Polyolefin | Polybutadiene | B-3000 | | | | | |
| | | B-1000 | | | | | |
| | | Ricon 150 | | | | | |
| Hydrogenated | Hydrogenated styrene- | H1052 | 10 | 5 | | | |
| polyolefin | butadiene-styrene | H1054 | | 5 | | | |
| | triblock copolymer | | | | | | |
| Additional additive | Polyphenylene ether | SA9000 | | | | | |
| | Triallyl isocyanurate | TAIC | | | | | |
| Hardening | Imidazole | C11Z | 0.1 | 0.1 | 0.1 | | 0.1 |
| accelerator | | 2Pz | | | | | |
| | Peroxide | 25B | | | | | |
| | Triphenylphosphine | TPP | | | | 0.1 | |
| Inorganic filler | Spherical silica | SC2050 SMJ | 150 | 150 | 150 | 150 | 150 |
| | | SC2050 SVJ | 30 | 30 | 30 | 30 | 30 |

| Solvent | Butanone | 10 | 30 | 30 | 120 | 150 |
|---|---|---|---|---|---|---|
| | Toluene | 80 | 30 | 30 | 80 | 80 |

| Characteristics | Test condition | Unit | C6 | C7 | C8 | C9 | C10 |
|---|---|---|---|---|---|---|---|
| Dk | | No unit | 3.15 | 3.16 | 3.15 | 3.32 | 3.34 |
| Df | | No unit | 0.00205 | 0.00233 | 0.00213 | 0.00552 | 0.00412 |
| Observation of | | No unit | Yes | No | No | No | No |
| striation bubbles | | | | | | | |
| X- CTE | | ppm/° C. | 9.1 | 17.6 | 15.2 | 8.9 | 9.3 |
| Appearance of | | No unit | No | No | No | Yes | Yes |
| prepreg | | | | | | | |
| Interlayer bonding | | lb/in | 1.8 | 2.5 | 2.5 | 3.2 | 2.7 |
| strength | | | | | | | |
| Copper foil peel | | lb/in | 2.5 | 2.9 | 2.9 | 3.4 | 3.1 |
| strength | | | | | | | |
| Solder dipping | | No unit | OK | Fail | OK | Fail | OK |
| Multilayer laminate | | No unit | Fail | Fail | Fail | Fail | Fail |
| heat resistance | | | | | | | |
| High temperature | Stiffness 1 | N/m | 1221.81 | 2150.3 | 2070.3 | 3386.1 | 3592.1 |
| stiffness difference | (@50° C.) | | | | | | |
| | Stiffness 2 | N/m | 761.837 | 967.11 | 943.33 | 2800.8 | 2911.8 |
| | (@250° C.) | | | | | | |
| | ΔStiffness | % | 37.6% | 55.0% | 54.4% | 17.3% | 18.9% |
| | (@50° C. − 250° C.) | | | | | | |

### Varnish

According to the amounts shown Table 1 to Table 4, the components of each Embodiments (abbreviated as E, such as E1 to E8) and Comparative embodiments (abbreviated as C, such as C1 to C10) were respectively added into the stirring tank and stirred. After mixing uniformly, the obtained resin composition was called as a varnish.

The formulation method of the resin composition of Embodiment 1 (E1) is used as an example. 100 parts by weight of maleimide A, 3 parts by weight of BI-3000 and 10 parts by weight of BVPE were added into a stirrer containing 30 parts by weight of butanone and 50 parts by weight of toluene, followed by stirring until BVPE was completely dissolved and all components were mixed evenly. Then, 100 parts by weight of SC-2050 SMJ, 30 parts by weight of SC-2050 SVJ and 0.1 parts by weight of C11Z were added and continuously stirred to mix evenly to obtain the varnish of the resin composition of Embodiment E1.

In addition, according to the amounts shown in Table 1 to Table 4, the varnishes of the resin compositions of Embodiments 2 to 8 (E2 to E8) and Comparative embodiments 1 to 10 (C1 to C10) were prepared with reference to the preparation method of the varnish of Embodiment 1 (E1).

With reference to the following methods, the varnishes of Embodiments 1 to 8 (E1 to E8) and Comparative embodiments 1 to 10 (C1 to C10) were used to prepare the samples (respectively including prepregs, copper-containing laminates and copper-free laminates) to be tested. Then, the characteristic analyses were performed according to the following specific conditions.

### Prepreg 1 (Using 1035 L-Glass Fiber Fabric)

The resin compositions in different Embodiments (E1 to E8) and Comparative embodiments (C1 to C10) listed in Table 1 to Table 4 were respectively put into an impregnation tank in batches. The glass fiber fabric (such as 1035 L-glass fiber fabric) was passed through the above impregnation tank, and the resin compositions were adhered to the glass fiber fabric. After heating at 130° C. for 4 minutes, the resin compositions were turned into the semi-cured state (B-Stage) to obtain the prepreg 1 (the resin content is about 70%).

### Prepreg 2 (Using 2116 L-Glass Fiber Fabric)

The resin compositions in different Embodiments (E1 to E8) and Comparative embodiments (C1 to C10) listed in Table 1 to Table 4 were respectively put into an impregnation tank in batches. The glass fiber fabric (such as 2116 L-glass fiber fabric) was passed through the above impregnation tank, and the resin compositions were adhered to the glass fiber fabric. After heating at 130° C. for 4 minutes, the resin compositions were turned into the semi-cured state (B-Stage) to obtain the prepreg 2 (the resin content is about 53%).

### Prepreg 3 (Using 1078 L-Glass Fiber Fabric)

The resin compositions in different Embodiments (E1 to E8) and Comparative embodiments (C1 to C10) listed in Table 1 to Table 4 were respectively put into an impregnation tank in batches. The glass fiber fabric (such as 1078 L-glass fiber fabric) was passed through the above impregnation tank, and the resin compositions were adhered to the glass fiber fabric. After heating at 130° C. for 4 minutes, the resin compositions were turned into the semi-cured state (B-Stage) to obtain the prepreg 3 (the resin content is about 70%).

Copper-containing laminate 1 (or called as copper-clad laminate 1, which is prepared by laminating two prepregs 1)

Two reverse treated copper foils (RTF copper foils) with a thickness of 18 μm and the same two aforementioned prepregs 1 were provided. One copper foil, two prepregs 1 and one copper foil were laminated in sequence, and the lamination was performed under a vacuum condition at 500 psi and 220° C. for 150 minutes to obtain a copper-containing laminate 1.

### Copper-Free Laminate 1 (Which is Prepared by Laminating Two Prepregs 1)

The aforesaid copper-containing laminate 1 was etched to remove the copper foils on both sides to obtain a copper-free laminate 1, which is formed by laminating two prepregs 1.

### Copper-Containing Laminate 2 (Which is Prepared by Laminating One Prepreg 2)

The manufacturing method for the copper-containing laminate 2 is substantially similar to that for the copper-containing laminate 1, except that the copper-containing laminate 2 was formed by laminating one prepreg 2.

### Copper-Free Laminate 2 (Which is Prepared by Laminating One Prepreg 2)

The aforesaid copper-containing laminate 2 was etched to remove the copper foils on both sides to obtain a copper-free laminate 2, which is formed by laminating one prepreg 2.

### Copper-Containing Laminate 3 (Which is Prepared by Laminating Two Prepregs 2)

The manufacturing method for the copper-containing laminate 3 is substantially similar to that for the copper-containing laminate 1, except that the copper-containing laminate 3 was formed by laminating two prepregs 2.

### Copper-Free Laminate 3 (Which is Prepared by Laminating Two Prepregs 2)

The aforesaid copper-containing laminate 3 was etched to remove the copper foils on both sides to obtain a copper-free laminate 3, which is formed by laminating two prepregs 2.

### Copper-Containing Laminate 4 (Which is Prepared by Laminating Four Prepregs 2)

The manufacturing method for the copper-containing laminate 4 is substantially similar to that for the copper-containing laminate 1, except that the copper-containing laminate 4 was formed by laminating four prepregs 2.

### Copper-Free Laminate 4 (Which is Prepared by Laminating Four Prepregs 2)

The aforesaid copper-containing laminate 4 was etched to remove the copper foils on both sides to obtain a copper-free laminate 4, which is formed by laminating four prepregs 2.

### Copper-Containing Laminate 5 (Which is Prepared by Laminating Eight Prepregs 2)

The manufacturing method for the copper-containing laminate 5 is substantially similar to that for the copper-containing laminate 1, except that the copper-containing laminate 5 was formed by laminating eight prepregs 2.

### Copper-Free Laminate 5 (Which is Prepared by Laminating Eight Prepregs 2)

The aforesaid copper-containing laminate 5 was etched to remove the copper foils on both sides to obtain a copper-free laminate 5, which is formed by laminating eight prepregs 2.

The test methods and characteristic analysis items for the aforementioned samples to be tested are explained as follows.

### Dielectric Constant (Dk)

In the measurement of the dielectric constant, the aforesaid copper-free laminate 1 (which is prepared by laminating two prepregs 1) was used as the sample to be tested. A microwave dielectrometer (available from Japan AET company) was used. According to the method described in JIS C2565, each sample to be tested was measured at room temperature (about 25° C.) and at a frequency of 10 GHz. The lower the dielectric constant, the better the dielectric property of the sample to be tested. At the measurement frequency of 10 GHz and the Dk values less than 3.40, the difference in the Dk values less than 0.05 represents no significant difference in the dielectric constant of different laminates, and the difference in the Dk values greater than or equal to 0.05 represents a significant difference in the dielectric constant of different laminates (there is significant technical difficulty).

### Dissipation Factor (Df)

In the measurement of the dissipation factor, the aforesaid copper-free laminate 1 (which is prepared by laminating two prepregs 1) was used as the sample to be tested. A microwave dielectrometer (available from Japan AET company) was used. According to the method described in JIS C2565, each sample to be tested was measured at room temperature (about 25° C.) and at a frequency of 10 GHz. The lower the dissipation factor, the better the dielectric property of the sample to be tested. At the measurement frequency of 10 GHz and the Df value less than 0.00250, the difference in the Df values less than 0.00010 represents no significant difference in the dissipation factor of different laminates, and the difference in the Df values greater than or equal to 0.00010 represents a significant difference in the dielectric constant of different laminates (there is significant technical difficulty). At the measurement frequency of 10 GHz and the Df value greater than or equal to 0.00250 and less than 0.00600, the difference in the Df values less than 0.00050 represents no significant difference in the dissipation factor of different laminates, and the difference in the Df values greater than or equal to 0.00050 represents a significant difference in the dissipation factor of different laminates (there is significant technical difficulty).

### Observation Whether Striation Bubbles are Present in a Copper-Free Laminate

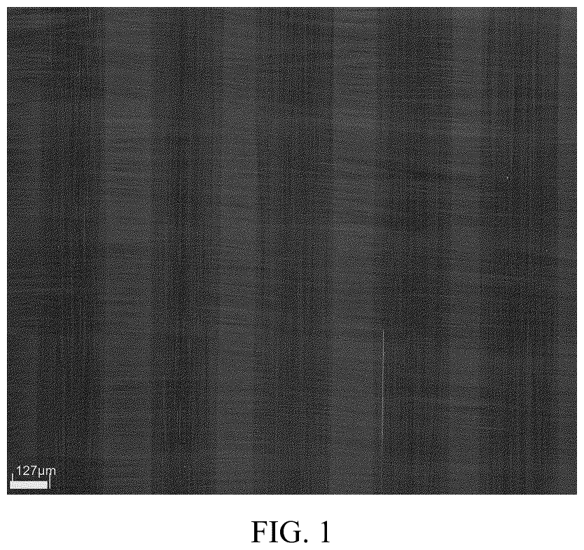

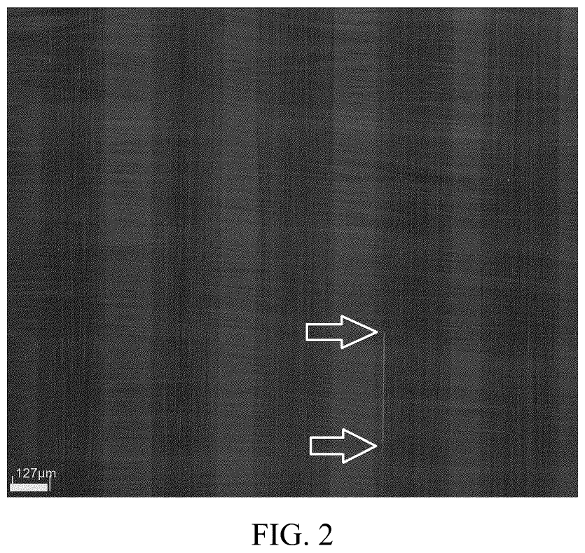

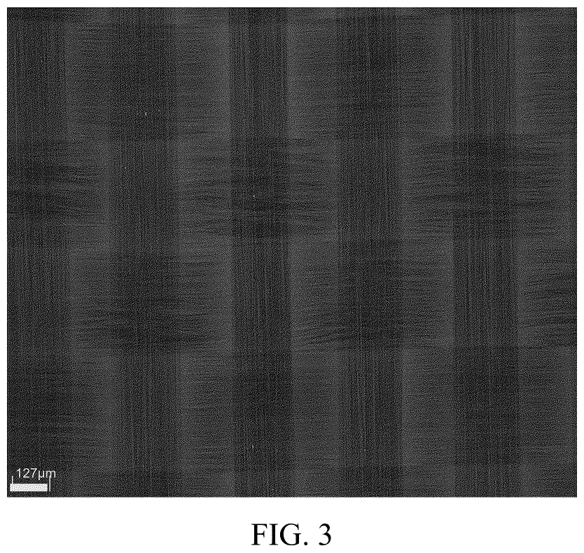

In the observation whether striation bubbles are present in a copper-free laminate, the aforesaid copper-free laminate 2 (which is prepared by laminating one prepreg 2) was used as the sample to be tested to perform optical microscope observation. Testers used an optical microscope to observe whether there are striation bubbles inside the insulating layer of the copper-free laminate 2. If there are striation bubbles with a length greater than or equal to 5 mils, it is judged as “yes”. If there are no striation bubbles with a length greater than or equal to 5 mils, it is judged as “no”. Please refer to FIG. 1 and FIG. 2. In FIG. 1, there are striation bubbles with a length greater than or equal to 5 mils (5 mils is equal to 127 μm (micron)). The long vertical straight line indicated by two arrows in FIG. 2 represents the presence of a striation bubble with the length greater than or equal to 5 mils. In FIG. 3, there are no striation bubbles with a length greater than or equal to 5 mils. If there are striation bubbles in the copper-containing laminate, the copper-free laminate or the insulation layer of the printed circuit board, it will cause the subsequent printed circuit board has the short circuit problem resulting from the conductive anodic filamentation (CAF) forming from the conductive ion migration, causing the printed circuit board to fail and be scrapped.

### X-Axis Coefficient of Thermal Expansion (X-CTE)

In the measurement of the X-axis coefficient of thermal expansion, a copper-free laminate 3 (which is prepared by laminating two prepregs 2) was selected as the sample to be tested for thermal mechanical analysis (TMA). The aforesaid copper-free laminate 3 was cut into a sample with a length of 24 mm and a width of 3 mm. The sample was heated in the temperature range from 35° C. to 260° C. at a heating rate of 10° C. per minute. The X-axis coefficient of thermal expansion (α1) (unit: ppm/° C.) of each sample to be tested in the temperature range from 40° C. to 125° C. was measured according to the method described in IPC-TM-650 2.4.24.5. In the present invention, the X-axis coefficient of thermal expansion refers to the thermal expansion coefficient of the sample to be tested at the X-axis. The lower the X-axis coefficient of thermal expansion, the better the dimensional expansion and contraction characteristics. When the difference in X-axis coefficient of thermal expansion is greater than or equal to 0.5 ppm/° C., it means that there is a significant difference in the X-axis coefficient of thermal expansion between different laminates (there is significant technical difficulty). For example, according to the article manufactured by the resin composition of the present invention, the X-axis coefficient of thermal expansion thereof measured with reference to the method described in IPC-TM-650 2.4.24.5 is less than or equal to 10.0 ppm/° C., and for example, between 8.0 ppm/° C. and 10.0 ppm/° C.

### Appearance of Prepreg

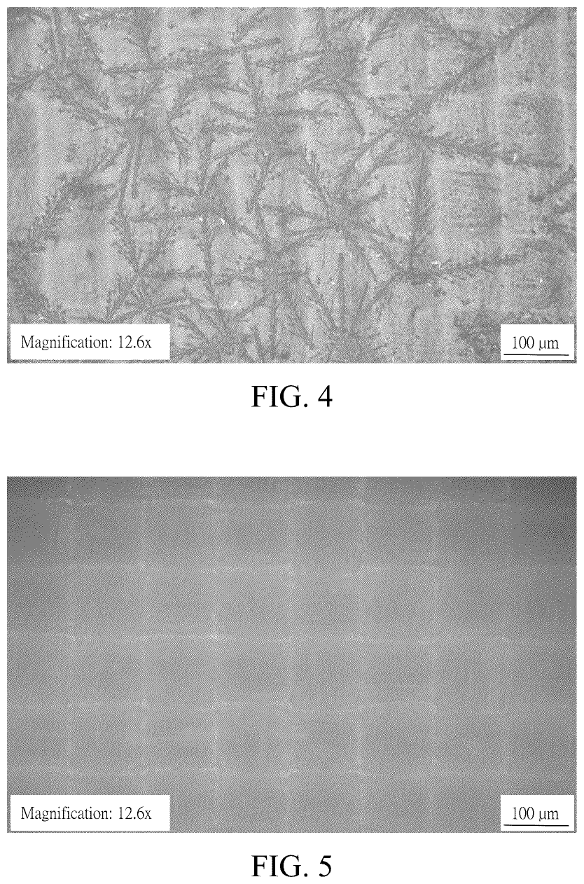

The prepreg 1 prepared by impregnating each sample to be tested (each Embodiments or Comparative embodiments) with the above-mentioned 1035 L-glass fiber fabric. An optical microscope was used to observe whether there are crystals in its appearance. If there are no crystals, mark it as “no”. FIG. 5 is a schematic diagram showing an appearance of a prepreg 1 without crystals. On the contrary, if there are crystals, mark it as “yes”. FIG. 4 is a schematic diagram showing an appearance of a prepreg 1 with crystals. If there are crystals on the surface of the prepreg, it will easily cause powders of the prepreg to fall off, further causing the resin content of the prepreg incorrect and have to be scrapped

### Interlayer Bonding Strength (B/S)

The copper-containing laminate 4 (which was prepared by laminating four prepregs 2) was cut into a rectangular sample with a width of 12.7 mm and a length greater than 60 mm. According to the method described in IPC-TM-650 2.4.8, an universal tensile strength testing machine was used to measure. There is no need to etch the surface copper foil during the process, and the test position is the joint surface of the second layer of the prepreg and the third layer of the prepreg. At room temperature (about 25° C.), the force required to separate the aforesaid two layers of the laminates after curing was measured (unit: lb/inches, lb/in). In the present field, the higher the interlayer bonding strength, the better. The higher the interlayer bonding strength, the better. If the difference in the interlayer bonding strength of different samples to be tested is greater than or equal to 0.1 lb/in, it means there is a significant difference and there is significant technical difficulty.

### Copper Foil Peel Strength (P/S)

The copper-containing laminate 4 (which was prepared by laminating four prepregs 2) was cut into a rectangular sample with a width of 24 mm and a length greater than 60 mm, and the copper foil thereon was etched to leave a strip copper foil with a width of 3.18 mm and a length greater than 60 mm. According to the method described in IPC-TM-650 2.4.8, an universal tensile strength testing machine was used to measure the force required to pull the copper foil away from the surface of the laminate (unit: lb/inches, lb/in) at room temperature (about 25° C.). The higher the copper foil peel strength, the better. The difference between the copper foil peel strength values of different samples to be tested being greater than or equal to 0.1 lb/in represents a significant difference (there is significant technical difficulty).

### Solder Dipping (S/D)

The copper-containing laminate 5 (which was prepared by laminating eight prepregs 2) was used as the sample to be tested, which was cut into a sheet with a length of 20 cm and a width of 10 cm. Referring to the method described in IPC-TM-650 2.4.23, the sample to be tested was immersed in a tin furnace with a constant temperature of 288° C., and taken out after immersing for 20 seconds to check whether there is any board explosion. If the board is exploded, it will fail and be marked “fail”. If the board is not exploded, it will pass the test and be marked “OK”. For example, interlayer delamination between insulating layers is called board explosion. The interlayer delamination will cause blistering and separation between any layers of the laminate.

### Multilayer Laminate Heat Resistance

A core board was prepared according to the following method. Prepregs 2 were respectively provided which were prepared by impregnating 2116 L-glass fiber fabric with each sample to be tested (each of Embodiments or Comparative embodiments) (the resin content of each prepreg 2 is approximately 53%). RTF copper foils (with the thickness of 18 μm) were respectively laminated on both sides of the prepreg 2, and then pressed and cured under vacuum, high temperature (220° C.) and high pressure (500 psi) for 2.5 hours, and a copper-containing core board was obtained. Next, the copper foils on both sides of the above-mentioned copper-containing core board were etched to obtain a copper-free core board (with the thickness of 5 mils). Three copper-free core boards were prepared according to the aforesaid methods. Next, two RTF copper foils (with the thickness of 18 μm) and eight prepregs 3 which were prepared by impregnating 1078 L-glass fiber fabric with each sample to be tested (each of Embodiments or Comparative embodiments) (the resin content of each prepreg 3 is about 70%) were provided. One copper foil, two prepregs 3 (prepared by using 1078 L-glass fiber fabric), one copper-free core board, two prepregs 3 (prepared using 1078 L-glass fiber fabric), one copper-free core board, two prepregs 3 (prepared using 1078 L-glass fiber fabric), one copper-free core board, two prepregs 3 (prepared using 1078 L-glass fiber fabric) and one copper foil were laminated in sequence, and the lamination was performed under a vacuum condition at 500 psi and 220° C. for 2.5 hours to obtain an eight-layer laminate with the outer layers being copper foils. The eight-layer laminate was cut into a rectangular sample with a length of 5.9 inches and a width of 2.2 inches. A total of 500 through holes with a diameter of 0.3 mm were formed on the surface of the rectangular sample using the circuit board drilling process (a 20×25 through hole matrix, wherein the vertical distance between adjacent hole walls is 0.25 mm). Electroplated copper was then formed on the hole walls to obtain a multilayer laminate sample for the heat resistance test.

In the test of the multilayer laminate heat resistance, the above samples for multilayer laminate heat resistance were used to be tested. The test was performed referring to the method described in IPC-TM-650 2.4.13.1. The sample was placed horizontally on (that is, contact) the tin liquid surface in a tin furnace with a constant temperature of 288° C. During each test, one side of the sample was placed on the tin surface for 10 seconds. After 10 seconds, the sample was removed from the tin surface and cooled at room temperature for 30 seconds. The same side of the sample was placed on the tin surface again for 10 seconds. After 10 seconds, the sample was taken out again and cooled at room temperature for 30 seconds. The sample is placed on the tin surface for 10 seconds and cooled at room temperature for 30 seconds, and the above steps are regarded as one time. The above steps were repeated to test the total number of times that each sample to be tested can withstand heat without board explosion. If the total number of tests exceeds 20 times and the board is still unexploded, it will be marked as “OK”. If the total number of tests is less than or equal to 20 times and the board is exploded, it will be marked as “Fail”. Generally, the greater the total number of times that each sample to be tested can be repeatedly subjected to the tin dipping heat resistance test without board explosion means that the heat resistance of the products (such as copper clad laminates) made by using the resin composition is better. The above-mentioned “board explosion” can be understood as interlayer peeling or blistering. Board explosion may occur between any layers of the laminate. For example, interlayer peeling between insulating layers can be called board explosion. For example, bubbling and separation between copper foil and insulating layers can also be called board explosion. Because the multilayer laminate contains multiple layers of copper foils and has been processed by the circuit board drilling process, the heat resistance test results thereof can truly reflect the heat resistance of the printed circuit board. The heat resistance test results of ordinary double-layer laminate without circuit board drilling process cannot accurately predict the heat resistance of multilayer laminates, that is, the heat resistance of printed circuit boards cannot be predicted.

High Temperature Stiffness Difference, Marked as ΔSiffness or Abbreviated as ΔS

The copper-free laminate 4 (which was prepared by laminating four prepregs 2) was used to measure the stiffness thereof at 50° C. and 250° C. respectively with a DMA instrument. The measurement method refers to the method described in IPC-TM-650 2.4.24.4, and the unit is N/m. The stiffness measured at 50° C. is defined as S1, the stiffness measured at 250° C. is defined as S2, and high temperature stiffness difference is calculated by ΔS=[(S1−S2)/S1]*100%, wherein the unit is %. The lower the high temperature stiffness difference, the better. The difference between high temperature stiffness differences greater than or equal to 1% is a significant difference, and the difference between high temperature stiffness differences less than 1% is not a significant difference.

Referring to the test results of Table 3, the appearance of the copper-free laminate 1 and the copper-free laminate 3 produced by Comparative embodiment C1 is rough and uneven. In addition, the interlayer adhesion of the copper-free laminate 1 to the copper-free laminate 5 and the copper-containing laminate 1 to the copper-containing laminate 5 produced in Comparative embodiment C1 is very poor, and the layers of the insulating layers are easily separated. Therefore, for Comparative embodiment C1, the above-mentioned various characteristic analyses cannot be conducted and multiple data cannot be obtained.

According to the above embodiments, articles prepared by the resin composition of the present invention (for example, prepregs, resin films, laminates or printed circuit boards) have excellent characteristics in at least one of X-axis coefficient of thermal expansion, the appearance of prepregs, the surface of laminates and a tensile force on a copper foil, and therefore can be used as a high-performance laminate that meet comprehensive needs.

Although the present invention is disclosed in the foregoing embodiments, they are not intended to limit the present invention. All changes and modifications made without departing from the spirit and scope of the present invention shall fall within the scope claimed in the present invention. Regarding the scope claimed by the present invention, please refer to the attached claims.

1. A resin composition, comprising:
100 parts by weight of maleimide resin represented by the following formula (1);
1.5 parts by weight to 20 parts by weight of hydrogenated polybutadiene; and
10 parts by weight to 35 parts by weight of a vinylbenzyl-containing compound, 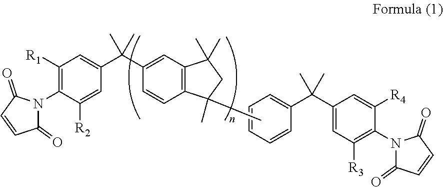
wherein n is an average number of a repeating unit based on a number-average molecular weight, n is a numerical value ranging from 1 to 20, and each R₁ to R₄ independently is H or C₁₋₃ alkyl.

2. The resin composition of claim 1, wherein the maleimide resin represented by the formula (1) is a maleimide resin respresented by the following formula (1.1): 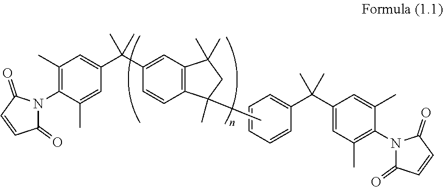
wherein n is an average number of a repeating unit based on a number-average molecular weight, and n is a numerical value ranging from 1 to 20.

3. The resin composition of claim 1, wherein the vinylbenzyl-containing compound comprises: divinyl diphenylethane, a vinylbenzyl-containing compound represented by the following formula (2) or a combination thereof: 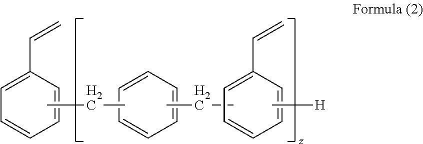
wherein z is an average number of a repeating unit based on a number-average molecular weight, and z is a numerical value ranging from 1 to 20.

4. The resin composition of claim 3, wherein the divinyl diphenylethane comprises: p,p-divinyl-1,2-diphenylethane, p,m-divinyl-1,2-diphenylethane, m,m-divinyl-1,2-diphenylethane or a combination thereof.

5. An article manufactured using the resin composition of claim 1, wherein the article includes a prepreg, a resin film, a laminate or a printed circuit board.

6. The article of claim 5, which has at least one of the following characteristics:
no striation bubbles observed inside a copper-free laminate by using an optical microscope; and
no crystal observed on a surface of a prepreg by using an optical microscope.

7. The article of claim 5, which has at least one of the following characteristics:
a dissipation factor measured at a frequency of 10 GHz with reference to a method described in JIS C2565 being less than or equal to 0.00210;
an X-axis coefficient of thermal expansion measured with reference to a method described in IPC-TM-650 2.4.24.5 being less than or equal to 10.0 ppm/° C.;
a peel strength of a copper foil of a copper-containing laminate measured with reference to a method described in IPC-TM-650 2.4.8 being greater than or equal to 2.7 pounds/inch; and
a high temperature stiffness difference measured with reference to an IPC-TM-650 2.4.24.4 standard being less than or equal to 40.0%.
